(19) United States
(12) Patent Application Publication
(10) Pub. No.: US 2007/0029735 A1
(43) Pub. Date: Feb. 8, 2007

(54) Self-compensating dynamic joint

(76) Inventor: Dominique Moreau, Issy-Les-Moulineaux (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/571,928

(22) PCT Filed: Sep. 15, 2004
(86) PCT No.: PCT/EP04/52192

§ 371 Date: Mar. 15, 2006

(30) Foreign Application Priority Data
Sep. 16, 2003 (FR) 03/10866

(51) Int. Cl. F16J 15/00

(52) U.S. Cl. 277/300

(57) ABSTRACT

The invention relates to a self-compensating dynamic joint between two parts of a piece of equipment, namely a fixed part and a moving part rotatable about an axis of rotation of the fixed part, to ensure the sealing of the equipment with respect to the outside comprising : a sealing part having a given coefficient of thermal expansion, provided with an end in frictional contact with a frictional surface of a first part, and mounted in a sealed way in a rigid mechanical structure connected to the second part, a compensation element, forming the link between the mechanical structure and the second part in a sealed way, said compensation element being thermally deformable and designed in such a way that, when the temperature varies, the displacements of the mechanical structure resulting from the deformations of the compensation element ensure that said end of the sealing part is kept in frictional contact with the frictional surface.

### TECHNICAL FIELD

The present invention relates to a self-compensating dynamic joint between two parts of a piece of equipment, namely a fixed part and a part rotatable about an axis of rotation of said fixed part, for providing a given degree of sealing of the equipment in respect of solid particles and/or fluids of external origin. It is particularly suitable for sealing aeronautical equipment mounted on a carrier.

### BACKGROUND OF THE INVENTION

Aeronautical equipment mounted as an external load is subject to extreme environments in terms of temperature, pressure and penetration by sand, dust or rain, yet it must provide a sufficient degree of sealing for all the sub-assemblies of the optical or laser type located inside the equipment, in order to keep them in operational condition in all configurations of the flight envelope of the carrier. This performance is currently achieved by means of extremely costly dynamic joints of the ferrofluid type.

In order to reduce costs, standard joints of the lip seal type can be used, in association with moisture absorbers of the desiccant powder type, which can compensate to some extent for the inadequate seal. However, these joints, conventionally made from elastomers, have a coefficient of expansion such that, when subjected to a temperature reduction, they contract so that the sealing provided by the joint is decreased or even lost altogether. When subjected to a rise in temperature, they expand, thus increasing the frictional torque to an unacceptable degree in equipment in which the available power is small.

### SUMMARY OF THE INVENTION

The present invention enables the aforesaid drawbacks to be overcome by proposing a low-cost dynamic joint which maintains the seal and has a constant or only slightly variable frictional torque during variations of temperature.

For this purpose, the dynamic joint according to the invention is self-compensating, as a result of the association of a sealing part of the conventional type with a compensation element having a given coefficient of expansion and arranged in such a way that, when temperature variations occur, the expansion or contraction of the compensation element causes the sealing part to move in such a way that, in particular, the necessary seal is maintained.

More precisely, the invention proposes a self-compensating dynamic joint between two parts of a piece of equipment, namely a fixed part and a part rotatable about an axis of rotation of said fixed part, to provide a given degree of sealing of the equipment in respect of solid particles and/or fluids of external origin, characterized in that it comprises:

a sealing part having a given coefficient of thermal expansion, provided with an end in frictional contact with a frictional surface of a first one of the said parts, and mounted in a sealed way in a rigid mechanical structure connected to the second part,

a compensation element, forming the link between said mechanical structure and said second part in a sealed way, said compensation element being thermally deformable and designed in such a way that, when the temperature varies, the displacements of the mechanical structure resulting from the deformations of the compensation element ensure that said end of the sealing part is kept in frictional contact with the frictional surface of said first part with the desired degree of sealing.

The invention also relates to a rotary connection equipped with a self-compensating dynamic joint according to the invention.

### BRIEF DESCRIPTION OF THE DRAWINGS

Other advantages and characteristics will be made clearer by the following description, illustrated by the attached figures which show:

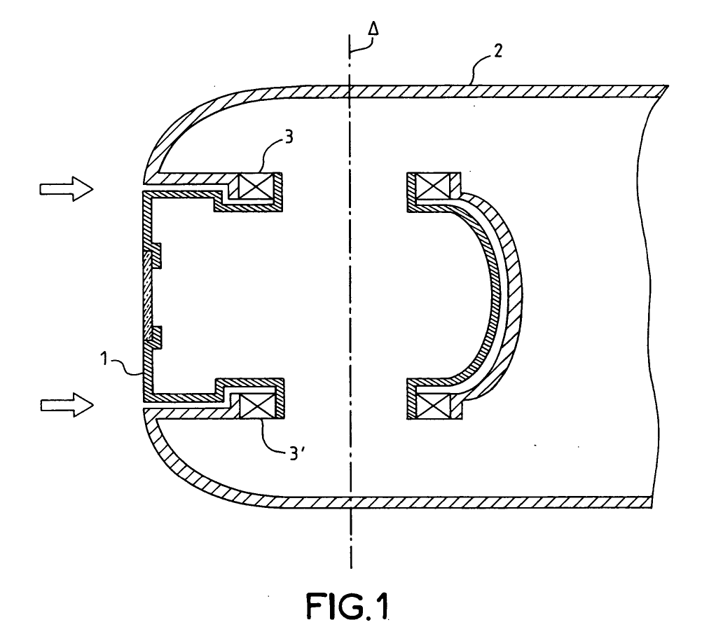

in FIG. 1, a diagrammatic partial view of equipment containing a rotary connection according to the invention;

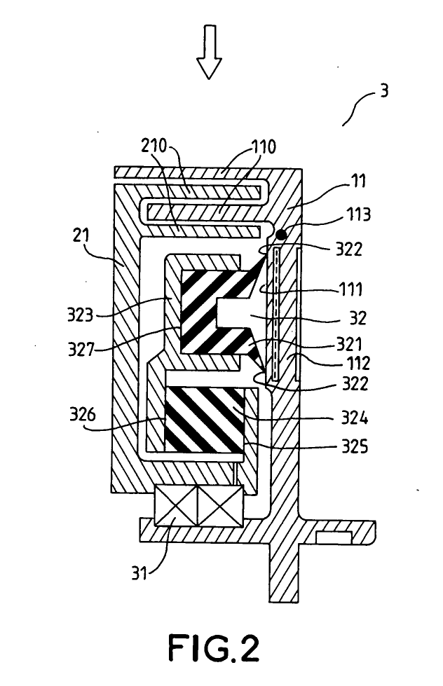

in FIG. 2, a diagram of an example of embodiment of a self-compensating dynamic joint according to the invention.

In these figures, identical elements are indicated by the same references.

### DETAILED DESCRIPTION

FIG. 1 shows a diagram of equipment containing a rotary connection according to the invention. The equipment is, for example, aeronautical equipment to be fitted on board, comprising optical and electronic sub-assemblies to perform different functions of surveillance, target tracking, etc. The sub-assemblies comprise components of the laser type and optical and electronic components, which are sensitive to variations of temperature and humidity. The equipment illustrated comprises a moving part 1, rotatable about an axis of rotation A of a fixed part 2. Two connectors 3, 3′ enable the moving part to rotate about the axis of rotation. This equipment is designed to withstand extreme environments, such as very wide temperature variations (common specifications are −54° to +100°), external attack (indicated by arrows in FIG. 1) by sand, dust and rain, and must still have a degree of sealing with respect to fluids, particularly moisture, which ensures an extremely low rate of leakage (a few millibars per 24 hours) under a typical bidirectional pressure difference of 1 bar between the inside and the outside of the equipment.

To provide this degree of sealing, these rotary connections comprise a dynamic joint. This joint must be able to withstand the pressure difference between the inside and outside, as well as temperature variations. A known example of a dynamic joint uses a ferrofluid material kept at a given differential pressure level by a magnetic field and providing a satisfactory degree of sealing with respect to the fluids. However, this device has the drawback of being heavy, bulky and very costly.

The invention proposes a self-compensating dynamic joint, of low cost and very small size, which enables a standard type of dynamic joint, such as a lip seal, to be used while ensuring a sufficient degree of sealing. FIG. 2 shows an example of embodiment of a rotary connection 3 between two parts of a piece of equipment, namely a fixed part and a moving part, incorporating a self-compensating dynamic joint according to the invention. In this example, the rotary connection comprises a first flange 11 fixed to a first one of said parts, for example the moving part, and a second flange 21 fixed to the second part, for example the fixed part. It also comprises a rotating bearing 31 mounted between the two flanges 11 and 21 to enable the moving part to rotate about an axis of rotation (not shown in FIG. 2) of the fixed part and the self-compensating dynamic joint 32 providing the desired degree of sealing.

According to the invention, the dynamic joint 32 comprises a sealing part 321 having a given coefficient of thermal expansion, provided with an end 322 in frictional contact with a frictional surface 111 of a first part (the fixed part or the moving part), and mounted in a sealed way in a rigid mechanical structure 323 connected to the second part. In this example, the frictional surface 111 is carried by the flange 11 fixed to the moving part, and the mechanical structure is connected to the flange 21 fixed to the fixed part. The dynamic joint also comprises a compensation element 324, forming the connection between the mechanical structure 323 and the second part (in this example, the flange 21) in a sealed way. According to the invention, the compensation element 324 is thermally deformable and designed in such a way that, when the temperature varies, the displacements of the mechanical structure 323 resulting from the deformations of the compensation element ensure that the frictional end 322 of the sealing part is kept in contact with the frictional surface 111 of the first part with the desired degree of sealing. Sealing is thus ensured, because the joints between the sealing part 321 and the mechanical structure 323 on the one hand, and those between the mechanical structure and the compensation element 324 and between the compensation element and the second part (flange 21) on the other hand, are hermetically sealed. Moreover, the contact of the frictional end 322 with the frictional surface 111 of the first part (flange 11) is maintained as a result of the deformation of the compensation element, which, by causing the sealing part to be displaced by means of the rigid mechanical structure, enables the deformation of the sealing part to be compensated. Advantageously, the compensation element is designed to maintain the degree of sealing and the frictional torque constant or only slightly variable throughout the range of temperature variations. This is particularly useful in systems, particularly on-board systems, in which the available power is limited, and consequently the rotary joint can become jammed if the frictional torque is too great.

Thus, because of the use of the compensation element, a conventional joint of the lip seal type can be used as the sealing piece, the frictional end 322 consisting of one or more lips, as shown in the example of FIG. 2. The lip seal can be a standard seal available on the market. At least two lips are necessary, particularly in the case of a bidirectional pressure difference.

FIG. 2 shows an advantageous example of the compensation element 324. This is formed by a ring of deformable compensation material, having a given coefficient of thermal expansion. The material is, for example, of the elastomer type. The ring is fixed, on the one hand, to the second part (flange 21) by a first interface 325 which is substantially parallel to the plane of the frictional surface 111 and located facing this plane, and, on the other hand, to the mechanical structure 323, by a second interface 326 which is substantially parallel to the first and is on the opposite side of the first interface from the frictional surface. In the example of FIG. 2, the ring has a rectangular cross section, but clearly other shapes are possible. Thus, if the temperature decreases, the contraction of the compensation element causes a displacement of the mechanical structure towards the frictional surface, enabling the contraction of the sealing part to be compensated. Conversely, if the temperature rises, the expansion of the compensation element causes a displacement of the mechanical structure in the opposite direction, enabling the expansion of the sealing part to be compensated. The compensation element is designed in such a way that the product of the coefficient of expansion of the compensation material and the distance between the interfaces is adapted to the extent of deformation of the sealing part in the range of temperature variation, to ensure the desired degree of sealing.

In some cases, there may be a thermal gradient at the rotary connection between the sealing part and the compensation element. In this case, the compensation element is designed in such a way that the product of the coefficient of expansion of the compensation material and the distance between the interfaces is also adapted to said gradient. In some cases, the compensation element can be designed to additionally compensate the effects of expansion of the flanges.

In practice, the sealing part 321 can be formed simply from a block of deformable material having a given coefficient of expansion, fixed to the mechanical structure 323 by a support surface 327 substantially parallel to the frictional surface 111. The material is, for example, of the elastomer type. In this case, the product of the coefficient of expansion of the compensation material and the distance between the interfaces 325 and 326 is adapted to the product of the coefficient of expansion of the deformable material forming the sealing part and the distance between the support surface 327 and the frictional end 322. For example, if the rotary connection is of the stabilized temperature type, and the compensation element and the sealing part are formed from the same material, both distances are substantially identical, in order to maintain the degree of sealing. The distance between the interfaces 325 and 326 is adjusted differently if there is a thermal gradient between the sealing part and the compensation element.

The self-compensating joint according to the invention can be produced simply by known methods, by fabricating a mold of the appropriate shape around the mechanical structure. The sealing part and the compensation element can be formed, for example, by hot injection of an elastomeric material into the mold, the elastomeric material adhering to the different interfaces as it cools. If the same material is used for the sealing part and the compensation element, the manufacturing process becomes even easier. An example of a material which is conventionally used is neoprene. If the sealing part is a standard joint, such as a lip seal available on the market, it is bonded to the mechanical structure and the compensation element can be manufactured by the method described above.

Advantageously, as shown in FIG. 2, each flange 11, 21 can support one or more baffles, indicated by 110 and 210 respectively, the baffles of the two flanges being interleaved to form a kind of labyrinth for protecting the sealing part 321 of the dynamic joint 32 from external attack, by dust, sand or rain for example.

In a variant, the first flange 11 which carries the frictional surface 111 comprises a heating element 112 in the proximity of said frictional surface. This heating element enables the frictional end 322 of the sealing part to be de-iced if necessary. It also enables a minimum temperature to be maintained in the frictional surface, to ensure a minimum value of the frictional torque between the frictional end of the sealing part and the frictional surface carried by the flange 11. If necessary, the flange 11 also comprises, in the proximity of the frictional surface, a heat sensor 113 for the control of the heating element. The self-compensating dynamic joint according to the invention is not limited to applications such as those described above. It can be applied advantageously to any device having a rotary connection between a moving part and a fixed part and in which a degree of sealing must be maintained in a given range of temperature variations.

1. A self-compensating dynamic joint between two parts of a piece of equipment, namely a fixed part and a part rotatable about an axis of rotation of said fixed part, to provide a given degree of sealing of the equipment in respect of solid particles and/or fluids of external origin, comprising.
a sealing part having a given coefficient of thermal expansion, provided with an end bearing on a bearing surface of a first one of the said parts, and mounted in a sealed way in a rigid mechanical structure connected to the second part,
a compensation element, forming the link between said mechanical structure and said second part in a sealed way, said compensation element being thermally deformable and designed in such a way that, when the temperature varies, the displacements of the mechanical structure resulting from the deformations of the compensation element ensure that said bearing end of the sealing part is kept in contact with the bearing surface of said first part with the desired degree of sealing.

2. The dynamic joint as claimed in claim 1, wherein the compensation element is formed by a ring of deformable compensation material, having a given coefficient of thermal expansion, said ring being fixed to said second part by a first interface substantially parallel to the plane of the bearing surface and facing the latter, and being fixed to the mechanical structure by a second interface substantially parallel to the first and on the opposite side of the first interface from the bearing surface, the product of the coefficient of expansion of the compensation material and the distance between the interfaces being adapted to the extent of deformation of the sealing part in the range of temperature variation to ensure the desired degree of sealing.

3. The dynamic joint as claimed in claim 2, wherein when there is a thermal gradient between the sealing part and the compensation element, said product of the coefficient of expansion of the compensation material and the distance between the interfaces is also adapted to said gradient.

4. The dynamic joint as claimed in claim 2, wherein the sealing part is formed from a block of deformable material having a given coefficient of expansion, fixed to the mechanical structure by a support surface which is substantially parallel to the bearing surface, the product of the coefficient of expansion of the compensation material and the distance between the interfaces being adapted to the product of the coefficient of expansion of said deformable material and the distance between said support surface and the bearing end of the sealing part.

5. The dynamic joint as claimed in claim 4, wherein the compensation material is identical to the deformable material from which the sealing part is formed.

6. The dynamic joint as claimed in claim 4, wherein the materials forming the sealing part and the compensation element are of the elastomeric type.

7. The dynamic joint as claimed in claim 1, wherein the sealing part is a lip seal, the bearing end consisting of one or more lips.

8. The dynamic joint as claimed in claim 7, wherein the sealing part is a standard lip seal.

9. A rotary connection between two parts of a piece of equipment, namely a fixed part and a moving part, comprising a first flange fixed to a first one of said parts, a second flange fixed to the second part, a rotating bearing mounted between the two flanges to enable the moving part to rotate about an axis of rotation (Δ) of the fixed part and a self-compensating dynamic joint as claimed in any one of the preceding claims, the bearing surface being carried by said first flange and the rigid mechanical structure of the dynamic joint being supported by said second flange of the second part.

10. The rotary connection as claimed in claim 9, wherein each flange supports one or more baffles, the baffles of the two flanges being interleaved to protect the sealing part of the dynamic joint from external attack.

11. The rotary connection as claimed in claim 9, wherein said first flange comprises a heating element in the proximity of said bearing surface.

12. The rotary connection as claimed in claim 11, wherein said first flange also comprises a temperature sensor in the proximity of said bearing surface for the control of said heating element.

13. The dynamic joint as claimed in claim 5, wherein the materials forming the sealing part and the compensation element are of the electromeric type.

14. The dynamic joint as claimed in claim 2, wherein the sealing part is a lip seal, the bearing end consisting of one or more lips.

15. The dynamic joint as claimed in claim 3, wherein the sealing part is a lip seal, the bearing end consisting of one or more lips.

16. The dynamic joint as claimed in claim 4, wherein the sealing part is a lip seal, the bearing end consisting of one or more lips.

17. The dynamic joint as claimed in claim 5, wherein the sealing part is a lip seal, the bearing end consisting of one or more lips.

18. The dynamic joint as claimed in claim 6, wherein the sealing part is a lip seal, the bearing end consisting of one or more lips.

19. The rotary connection as claimed in claim 9, wherein each flange supports one or more baffles, the baffles of the two flanges being interleaved to protect the sealing part of the dynamic joint from external attack.
